(19) United States
(12) Patent Application Publication
(10) Pub. No.: US 2025/0150547 A1
(43) Pub. Date: May 8, 2025

(54) METHOD FOR PRINTING ON A PAPER WEB

(71) Applicant: SWISS KRONO Tec AG, Luzen (CH)

(72) Inventors: Sebastian Dicke, Bantikow (DE); Sabrina Pfeiffer, Kyritz (DE); Falko Geitz, Zernitz-Lohm (DE); Frank Oldorff, Schwerin (DE)

(21) Appl. No.: 18/730,111

(22) PCT Filed: Jan. 24, 2023
(86) PCT No.: PCT/EP2023/051705

§ 371 Date: Jul. 18, 2024

(30) Foreign Application Priority Data
Jan. 25, 2022 (EP) 22153111.4

(51) Int. Cl. H04N 1/60

(52) U.S. Cl. CPC H04N 1/6052

(57) ABSTRACT

The disclosure relates to a method for printing a paper web with a print motif by use of a digital printing facility, wherein the method includes: providing a reference decor sample that contains a section of a digital image of the original sample of the print motif; providing a hyperspectral reference data set for the reference decor sample; printing a copy of the reference decor sample; creating a hyperspectral data set for the printed copy; comparing the created hyperspectral data set with the provided hyperspectral reference data set by use of an electrical control unit, wherein a degree of similarity is determined; and using the reference decor sample when printing the print motif onto the paper web when the degree of similarity lies within a predetermined range, wherein the position of the print width of the copy corresponds to the position of the print width of the reference decor sample.

### FIELD OF INVENTION

The invention relates to a method for printing a paper web with a print motif by means of a digital printing facility, wherein the method comprises the following steps:
providing a reference decor sample that contains a section of a digital image of the original sample of the print motif,
providing a hyperspectral reference data set for the reference decor sample,
printing a copy of the reference decor sample,
creating a hyperspectral data set for the printed sample,
comparing the created hyperspectral data set with the provided hyperspectral reference data set by means of an electrical control unit, wherein a degree of similarity is determined, and
using the reference decor sample when printing the print motif onto the paper web when the degree of similarity lies within a predetermined range.

### BACKGROUND

Print motifs are printed on paper webs for a wide variety of reasons. For example, they are used to produce panels or boards that can be used, for example, as floor, wall or ceiling coverings or furniture boards. When manufacturing floor panels in particular, it is desired and very advantageous if the paper webs featuring the print motif do not differ from each other in terms of color. In particular, this is the case when panels with the same decor are produced at different times, meaning that the same decor is printed onto different paper webs at different times. In order to achieve reproducibility and color fidelity, it is known from the prior art to store a reference decor sample. It contains a section of a digital image of an original sample of a print motif as well as further information used, for example, to control the digital printing facility. Said information may contain, for example, color settings, application quantities and/or other parameters of the digital printing facility. In the present case, the reference decor sample preferably contains the control file with which the digital printing facility is controlled.

In addition, a hyperspectral reference data set for the reference decor sample is provided. To generate the hyperspectral reference data set, the reference decor sample was first used to print a copy. It was then captured hyperspectrally. For example, a hyperspectral measuring device, in particular a hyperspectral surface measuring device, is used manually or automatically. The measurement data of this measuring device are hyperspectral measurement data from which lab/LCH values and the corresponding color spaces can be calculated.

As a result, a print motif was printed onto a paper web and subsequently subjected to a quality check, for example. The paper web and the print motif printed on it were deemed good. In order to also be able to print the print motif onto further paper webs at a later point in time and achieve the same visual impression, the reference decor sample was created, in which the print parameters used during production of the printed paper web are stored. The parameters used are therefore stored in an electronic format and can be reused when production is restarted at a later point in time. Given that these parameters and the reference decor sample alone are not enough to ensure reproducibility of the visual impression, the hyperspectral reference data set of the printed paper web is also generated. To put it another way, the visual hyperspectral impression is saved in this data set.

The print motif can be, for example, a wood panel, a tile or multiple tiles, or a fantasy image, of which a digital image must first of all be created. A section of this digital image is generated, which is stored as a reference decor sample. This is done, for example, in an electronic memory.

The print motif is therefore only the image that is to be applied to the paper web. The print motif itself does not contain any information beyond the image information, such as color values and/or shade values of individual or all pixels of the print motif. Within the scope of the present invention, a “sample” is either a physical realisation of the print motif, for example a print or a digital image thereof, which contains the print motif and possibly further information. This information can be dependent or independent from the digital printing facility used for the method according to claim 1. The reference decor sample preferably contains information that can be used to control the digital printing facility and, particularly preferably, is sufficient to do so. The reference decor sample can therefore be used to print the print motif onto the paper web by means of the digital printing facility. To put it in a less formal and less technically precise way, one could say that the print motif is printed. However, since this only refers to the image itself, the digital printing facility is not able to process the “print motif”. It requires control commands and machine-readable information about which colors should be applied at which points on the paper web. Preferably, some of this information, especially preferably all the necessary information, is available in the reference decor sample, which is used accordingly when printing onto the paper web.

If the print motif is now to be printed onto a paper web, it must be ensured that the correct color values and color settings are used in order to generate a printed paper web using the digital printing facility whose decor corresponds to the original sample of the print motif as effectively as possible, preferably perfectly. To this end, a copy of the stored reference decor sample is printed onto the paper web. Whereas the reference decor sample is a digital element, the copy of the reference decor sample is a part of the printed paper web. Using the reference decor sample when printing onto the paper web ensures that the same print parameters are used that were used to generate the paper web assessed as good. A hyperspectral data set of the printed copy is subsequently created.

The hyperspectral data set created in this manner is now compared with the hyperspectral data set provided by means of an electrical control unit, preferably an electronic data processing device. Various methods and approaches to this are known from the prior art. What is important is that a degree of similarity is determined.

If the degree of similarity determined lies within the predetermined range, i.e. the similarity between the hyperspectral data set and the hyperspectrial reference data set is sufficiently large, the reference decor sample is used to print onto the paper web and production can begin. The predetermined range is preferably defined by a predetermined limit value, which defines a lower limit of the predetermined range. If the degree of similarity exceeds this predetermined limit value, for example 95%, the degree of similarity lies within the predetermined range. The predetermined limit value may also be 93%, 96%, 97% or another value.

### SUMMARY

This type of method is known from the prior art. However, deviations between the print motif on the paper web and the reference decor sample do still occur. The invention therefore aims to reduce or completely eliminate these deviations.

The invention solves the addressed task by way of a method according to the preamble of claim 1, which is characterized in that the position of the print width of the sample corresponds to the position of the print width of the reference decor sample.

The invention is based on the knowledge that the digital printing facility itself can have an impact on the decor printed onto the paper web. For example, print heads may print differently or the uniformity of the print may not be optimized across the print width of the digital printing system. To put it more simply, this means that printed samples of the reference decor sample may even differ when the color settings are the same, simply because they were printed at different positions of the print width of the digital printing facility. To enable optimal comparability of the created hyperspectral data set with the provided hyperspectral data set, the position of the print width of the copy is selected in such a way that it corresponds to the position of the print width of the reference decor sample.

The reference decor sample contains a section of the digital image of the original sample of the print motif. Said section has a position within the digital image that is identified by specifying a length position and a width position. The width position constitutes the position of the print width of the reference decor sample. The reference decor sample preferably contains a real section of the original sample. This means that part of the original sample is not represented by the reference decor sample. In this case, the printed copy of the reference decor sample does not depict the entire print motif, but only part of it. This is advantageous, but not essential. The reference decor sample can also contain the entire image of the original sample. In this case, the printed copy depicts the entire print motif.

If the reference decor sample is used when printing onto the paper web, the entire print motif is of course printed onto the paper web, even if the reference decor sample only depicts a section of the print motif. The reference decor sample is then completed to such an extent that the entire print motif can be printed. Nevertheless, in this case it is also said that the reference decor sample is used when printing the print motif onto the paper web.

In the event that the degree of similarity is not within the predetermined range, multiple copies of the reference decor sample are preferably printed with different color settings, wherein at least some of the copies are printed at the same position of the print width. Preferably, all copies are printed at the same position of the print width, particularly preferably corresponding to the position of the print width of the reference decor sample. It is particularly preferable if hyperspectral data sets are then determined for each of the printed copies and these are compared with the hyperspectral reference data set. In each case, a degree of similarity is determined. Advantageously, the copy whose hyperspectral data set exhibits the greatest similarity with the hyperspectral reference data set is then selected. The color values underlying this copy are then used to print the print motif onto the paper web.

Preferably, the various color settings are selected by the electrical control unit. To this end, it is beneficial if the electrical control unit not only determines the degree of similarity of the two hyperspectral data sets, but also different types or strengths of deviations and/or differences between them. Image recognition software and/or image processing software can be used for this purpose. Based on these detected deviations and/or differences, the electrical control unit suggests or selects color values. They are preferably selected in a such a way that the detected deviations and/or differences are compensated and reduced as much as possible.

In one preferred embodiment, all samples of the reference decor sample are printed at the same position of the print width of the digital printing facility. This means that the influences of the printing facility on the print can be prevented even more effectively.

In one preferred embodiment, the position of the print width corresponds to the position of the print width of the reference decor sample. The reference decor sample only contains a section of the digital image of the original sample of the print motif. It is not necessary to use and store the entire digital image of the original sample of the print motif to be printed onto the paper web as a reference decor sample. This would result in the majority of the printed copies of the reference decor sample containing the complete digital images of the original sample, which would increase the amount of space needed and ink used. To prevent this, only one part, namely one section, of the digital image of the original sample is used as a reference decor sample.

If the entire digital image is printed, the section is printed at a certain position of the print width of the digital printing facility. It is therefore advantageous if the printed copies of the reference decor sample, from whose digital images the comparison decor samples are created, are printed at the same position of the print width of the digital printing facility, so as to eliminate the influence of the digital printing facility itself as far as possible.

In one preferred embodiment, a printed reference copy of the reference decor sample is provided in addition to the reference decor sample, which refers to a digital element. The reference copy is a piece of a paper web onto which the reference decor sample has been printed. In this preferred embodiment, both the reference copy and the reference decor sample are provided and available for determining the quality of the comparison decor sample. The printed copy is preferably impregnated and pressed on a core, for example a wood-based material panel. This is preferably done together with the reference copy. The reference copy is therefore available from a previous printing process and is provided at the start of the process of the type described here together with the digital reference decor sample. It is then impregnated and pressed together with the printed copy which is printed in the course of the present method.

Preferably, the reference copy and the printed copy are divided into multiple, preferably at least three, parts prior to pressing, the reference copy and the printed copy preferably being identically divided. The various parts can then be mixed and assembled to form so-called mixed copies. A mixed copy is therefore a paper web or a piece thereof composed of multiple parts which together depict a printed copy of the reference decor sample.

The impregnated and pressed copies are preferably compared to each other in order to check color fidelity and reproducibility. This is especially easy to do if mixed copies are produced and compared. Even if the reference copy and the printed copy are each fully impregnated and pressed on a core, the comparison can still be carried out. For example, an operator of the method can look at the two copies and compare them. Alternatively or additionally, the comparison can also be done electronically. In this case, digital images, preferably in the form of a hyperspectral data set, are created of both the reference copy and the printed copy or of the respective mixed copies, which are then compared to each other by means of the electrical control unit, preferably an electronic data processing device.

Preferably, the provision of the reference decor sample comprises the following steps:
generating a digital image of an object that the print motif should imitate,
creating a color sample decor that contains a section of the image of the object,
printing a plurality of copies of the color sample decor with different color settings,
impregnating and pressing the copies of the color sample decor on a core,
comparing the impregnated and pressed copies with the object and
selecting an impregnated and pressed copy on the basis of the comparison and creating the reference decor sample from the selected copy.

In one preferred embodiment, in order to compare the impregnated and pressed copies with the object, digital images are generated, for example in the form of hyperspectral data sets, which are compared to each other.

Preferably, the copies of the color sample decors are printed at the same position of the print width of the digital printing facility.

### DETAILED DESCRIPTION

To be able to carry out the method, it is preferable to first develop a digital decor for output to a digital output device, for example a digital printing facility, for a wall, floor or ceiling covering or furniture made from a real material, for example. To this end, digital data are used, said data being obtained from scanning or photographing the template. The various digital data are then retouched, corrected and/or assembled in individual parts using image editing software. This results in a “repeat”, which is inserted into an output or into the template. It preferably contains markings for the output, such as cut marks, direction arrows, decor numbers and/or register crosses. Common sizes for such a repeat are, for example, between 100 cm×205 cm to 200 cm×205 cm, even though larger sizes are possible. Such a repeat is a digital image of the original sample.

Preferably, a section is subsequently used as a reference section in the color sample decor. The size of the reference section is preferably between the formats DIN A4 and DIN A1, especially preferably between DIN A4 and DIN A2, particularly preferably DIN A3.

The next steps are preferably used to approve the color settings of the reference decor sample. This should result in one color setting and generate a digital image which, as a printed copy, corresponds as effectively as possible to the original sample. To this end, multiple, preferably at least four, copies of the color sample decor are printed. In the process, different color settings are used which may contain, for example, different color values, different inks and/or different primers. The respective copies are preferably impregnated and pressed on a core. The comparison with a corresponding reference copy, which is preferably simultaneously impregnated and pressed, is preferably conducted in various lighting conditions and various types of light, such as D50, D60, mixed light and/or daylight. The reference decor sample is determined by comparing it with the original sample and used as the basis for the rest of the method.

The color setting of the reference decor sample is applied in the production file. If desired, a reference decor sample is created from said production file, which can be a different section than the one that has been used up to this point.

Multiple copies of the color sample decor are preferably printed at the same position of the print width of the digital printing facility, wherein various color settings are used. They contain parameters, such as ink or primer, that can be varied.

Digital images are generated from the printed copies of the color sample decor that are created in this manner. To this end, for example, a hyperspectral surface measuring device is used manually or automatically. The measurement data of this measuring device are hyperspectral measurement data from which lab/LCH values can be calculated. Professionals are familiar with the conversion of hyperspectral data sets and the determination of a degree of similarity. The current measurement data are compared with those of the reference decor sample by means of software in the electrical control unit and a degree of similarity is calculated from hyperspectral measurement data by means of the software. This degree of similarity can be output as a percentage, for example, or provided in the form of a formula.

The reference decor sample preferably features at least one marker, in particular at least one position marker and/or at least one control marker. It can contain a position marker which is used to position a hyperspectral measuring device, for example. The marker can also contain a control marker with which information is transmitted to a subsequent processing station, such as a laminating unit, and used to operate and/or control the processing station. This information can be used for impregnating and/or cutting the printed paper web to size.

The creation of the hyperspectral data set on the printed sample is preferably done by means of a recording device, preferably within the digital printing facility. This renders it unnecessary to have an additional device for recording the hyperspectral data set positioned outside of the digital printing facility and the facility requires less installation space. In addition, the method is accelerated and can react more quickly and easily to errors. This reduces the amount of waste.

In addition to the copy of the reference decor sample, comparison copies are preferably printed at different color settings, wherein the copy with the greatest degree of similarity is preferably used when printing the paper web. A hyperspectral data set is created for each of these printed copies, which is compared to the hyperspectral reference data set provided.

In one specific embodiment example, at a producer for laminate floorboards, decors are produced on decorative paper by means of an inkjet paper digital printing facility with inline primer application. Digital print data with a resolution of at least 300 dpi is required for color matching and production. When creating a new walnut wood decor, 20 different real wood planks are scanned or otherwise digitized using a high-resolution scanner. These data are retouched using software to produce a 205×140 cm format so that the grain and layout look harmonious and are approved. For color matching, an A3 section is taken from this file at a specified position and saved as a new matching file. Color versions are created in this file using software and printed on the digital paper printing facility, then impregnated, dried and pressed onto an HDF board until color version 26 is visually selected for the collection. When the color versions are output, two samples are cut from the proof. One is impregnated as described, dried and pressed onto an HDF board in order to obtain a visual approval of version 26 or the “finished” product including further processing. The second sample is then used to measure it with a hyperspectral measuring device when it is approved. This measurement is saved as a reference decor sample.

In addition, the color settings of version 26 are transferred from the matching file to the full production file and saved. Furthermore, a smaller file (comparison file) is created and saved with the specified A3 section, which corresponds to the color version 26 production file and the section of the reference decor sample. For the first production order of the walnut decor (for example 10 days later), the comparison file is printed first and measured with a hyperspectral measuring device without further processing. A similarity value to the reference decor sample of 92.6% is determined using software. The tolerance for the walnut decor was set to at least 95%. On the basis of the measured values and the calculated differences in the L, a, b, C, H and contrast values, further color modifications are created using software in a sample adjustment file on the basis of the approved color position and output on the digital paper printing facility and measured hyperspectrally until version 26-8 achieves a degree of similarity of 97.4%. These color modifications are then transferred to the production file and a new comparison file is also created for the start of production. Now 2 color versions are already available for the next production or the previous proof of the comparison file for the similarity comparison. The comparison prints >95% (ready for production) are also randomly impregnated, dried and pressed onto an HDF board to provide an additional visual check for the start of production.

In a second specific embodiment example, at a producer for laminate floorboards, decors are produced on decorative paper by means of an inkjet paper digital printing facility with inline primer application. A hyperspectral inline color measuring device is installed in this system. Digital print data with a resolution of at least 300 dpi is required for color matching and production. When creating a new oak wood decor, 14 different real wood planks are scanned and digitized using a high-resolution scanner. These data are retouched using software to produce a 205×130 cm format so that the grain and layout look harmonious and are approved. For color matching, an A3 section is taken from this file at a specified position and saved as a new matching file. Color versions are created in this file using software and printed on the digital paper printing facility, impregnated, dried and pressed onto an HDF board until color version 19 is visually selected for the collection.

In addition, the color settings of version 19 are transferred from the matching file to the full production file and saved. In this case, hyperspectral reference samples/reference data sets are created and saved inline at 4 prominent positions when said file is printed. At the start of the first production order for the oak decor (17 days later), the production file is printed and measured inline with a hyperspectral measuring device at the 4 prominent positions and comparison samples are saved. Using software, an average similarity value of 94.5% to the respective reference decor sample is calculated. The tolerance for the oak decor was set to at least 93%. The decor can be produced and a quality certificate created on the basis of the measurement data.

1. A method for printing a paper web with a print motif by use of a digital printing facility, wherein the method comprises:
providing a reference decor sample that contains a section of a digital image of an original sample of the print motif,
providing a hyperspectral reference data set for the reference decor sample,
printing a copy of the reference decor sample,
creating a hyperspectral data set for the printed copy,
comparing the created hyperspectral data set with the provided hyperspectral reference data set by use of an electrical control unit, wherein a degree of similarity is determined, and
using the reference decor sample when printing the print motif onto the paper web when the degree of similarity lies within a predetermined range,
wherein a position of the print width of the copy corresponds to a position of the print width of the reference decor sample.

2. The method according to claim 1, wherein, if the degree of similarity is not within a predetermined range, multiple copies of the reference decor sample are printed with different color settings, wherein at least some of the copies are printed at a same position of the print width, and the color settings are selected by the electrical control unit.

3. The method according to claim 1, wherein, in addition to the reference decor sample, a printed reference copy of the reference decor sample is provided, which is impregnated together with a printed copy and pressed on a core.

4. The method according to claim 3, wherein the reference copy and the printed copy are each split into multiple parts prior to pressing and compiled to create mixed copies.

5. The method according to claim 1, wherein the provision of the reference decor sample comprises:
generating a digital image of an object that the print motif should imitate,
creating a color sample decor that contains a section of the image of the object,
printing a plurality of copies of the color sample decor with different color settings,
impregnating and pressing the copies of the color sample decor on a core,
comparing the impregnated and pressed copies with the object, and
selecting an impregnated and pressed copy on a basis of the comparison and creating the reference decor sample from the selected copy.

6. The method according to claim 5, wherein in order to compare the impregnated and pressed copies with the object, digital images are generated, which are compared to each other.

7. The method according to claim 5, wherein the copies of the color sample decors are printed at a same position of the print width of the digital printing facility.

8. The method according to claim 7, wherein a position of the print width of the copies of the color sample decors corresponds to a position of the print width of the copies of the reference decor sample.

9. The method according to claim 1, wherein the reference decor sample features at least one marker and/or at least one control marker.

10. The method according to claim 1, wherein the creation of the hyperspectral data set on the printed copy is done by a recording device.

11. The method according to claim 1, wherein, in addition to the copy of the reference decor sample, comparison copies are printed at different color settings, wherein the copy with a greatest degree of similarity is used when printing the paper web.

12. The method according to claim 3, wherein the reference copy and the printed copy are each split into three parts prior to pressing and compiled to create mixed copies.

13. The method according to claim 1, wherein the reference decor sample features at least one position marker and/or at least one control marker.

14. The method according to claim 1, wherein the creation of the hyperspectral data set on the printed copy is done by the digital printing facility.
